(19) United States
(12) Patent Application Publication
(10) Pub. No.: US 2004/0083232 A1
(43) Pub. Date: Apr. 29, 2004

(54) Association learning for automated recommendations

(76) Inventors: Christopher Ronnewinkel, Heidelberg (DE); Matthias Kaiser, Mountain View, CA (US); Yuh-Cherng Wu, San Jose, CA (US)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/320,005

(22) Filed: Dec. 16, 2002

Related U.S. Application Data
(60) Provisional application No. 60/421,650, filed on Oct. 25, 2002.

(51) Int. Cl. G06F 17/00

(52) U.S. Cl. 707/104.1

(57) ABSTRACT

A system is disclosed to provide associative learning and recommendations. The system includes a learning engine recommendation process that provides one or more recommendations based on user input, a learning engine initiation process that generates initial training data, and a learning engine training process that transforms initial training data and subsequent training data into entity-pair relationships. The system may include user interfaces that allow each user to request and receive recommendations and a confirmation process that captures and stores training data based on user feedback regarding recommendations.

### CROSS-REFERENCE TO RELATED APPLICATIONS

This application claims the benefit of U.S. Provisional Patent Application Serial No. 60/421,650, filed on Oct. 25, 2002.

### TECHNICAL FIELD

This disclosure relates to association learning and automated recommendations.

### BACKGROUND

The increased capability of computers to store vast collections of information has led to a need for increasingly efficient techniques for information retrieval. Information retrieval refers to searching for relevant information in information systems that may contain numerous documents. Some information retrieval systems are based on keywords that index documents and a query language to retrieve documents from centralized document repositories according to those keywords. Typically, a text search engine is utilized that executes a query formulated by a user and returns a set of documents matching the keywords identified within the query. Some search engines may even predict what information is relevant to a user based on keywords identified in such a query. The above-mentioned techniques, however, are insufficient to meet the diversified information retrieval needs of some users. In addition, traditional information retrieval systems seldom identify the vast amount of potentially relevant documents that may best answer a particular user's need.

Various problems and limitations may be associated with some information retrieval systems. For example, in some information retrieval systems, there is no genuine interaction between user and system. The user merely accesses information in a passive fashion and a priori needs to know how to query relevant information with keywords. The effect of this is that users, both skilled and unskilled in information retrieval, must know how to characterize the information they are searching for with appropriate keywords before an actual search commences. The formulation of such a query is a difficult task, especially in light of the vast amount of information available on the Internet.

### SUMMARY

A system is disclosed to provide associative learning and recommendations. The system includes a learning engine recommendation process that provides one or more recommendations based on user input, a learning engine initiation process that generates initial training data, and a learning engine training process that transforms initial training data and subsequent training data into entity-pair relationships. The system may include user interfaces that allow each user to request and receive recommendations and a confirmation process that captures and stores training data based on user feedback regarding recommendations.

Various aspects of the system relate to generating entity-pair relationships from both implicit and explicit feedback mechanisms and providing recommendations from a directed graph.

For example, according to one aspect, a method includes generating correlation data from initialization data representing relations between entities, generating a directed graph from the correlation data, providing one or more recommendations from the directed graph using a request as input, storing training data in response to user activity, and adapting the correlation data using the training data as input

In some implementations, the method also may include spreading activation through nodes of the directed graph to provide recommendations.

In another aspect, a method includes receiving the request from a user, accessing a first set of one or more nodes on the directed graph matching the request, traversing one or more arcs connected to the first set of one or more nodes, accessing a second set of one or more nodes connected to one or more arcs, and recommending the second set of one or more nodes to the user.

In another aspect, a method includes displaying an interface prompting feedback from the user regarding the quality of recommendations and determing whether to store the request and one or more recommendations as the training data based upon the feedback.

In some implementations, the method may also include observing selected actions by a user based on one or more recommendations.

In another aspect, a method includes adapting correlation data by accessing training data using access controls, generating adaptation data from a learning rule using the training data as input, and adapting the correlation data using the adaptation data as input.

A system, as well as articles that include a machine readable medium storing machine-readable instructions for implementing the various techniques, are disclosed. Details of various implementations are discussed in greater detail below.

In some implementations, one or more of the following advantages may be present. In an e-commerce context the system may provide cross-selling opportunities by leveraging the knowledge learned from other customers. For example, if one customer is interested in purchasing a particular book, the system may provide recommendations of other books that customers may have purchased in connection with that particular book.

The system may also be used in the context of the World Wide Web (“WEB”). For example, a user searching the WEB may be interested in identifying similar websites relating to a topic. The system may record websites visited by other users in connection to the same topic and provide website recommendations thereof.

Another benefit of the system may be in a call center environment. For example, as experienced call center agents respond to customer questions, responses to those questions may be stored as training data in the system. Inexperienced agents responding to customers may benefit from the system by receiving recommendations based on experienced agent interactions with customers.

Additional features and advantages will be readily apparent from the following detailed description, the accompanying drawings and the claims.

### BRIEF DESCRIPTION OF THE DRAWINGS

FIG. 1 illustrates an example of a computer-based system for associative learning and automated recommendations.

FIG. 2 illustrates a correlation matrix for capturing knowledge.

FIG. 3 illustrates an associative network derived from a correlation matrix.

FIG. 4 illustrates spread activation applied once to an associative network.

FIG. 5 illustrates spread activation applied multiple times to an associative network.

FIG. 6 illustrates initial recommendations from a learning engine recommendation process.

FIG. 7 illustrates refined recommendations from a learning engine recommendation process.

FIG. 8 illustrates a learning engine configuration table.

### DETAILED DESCRIPTION

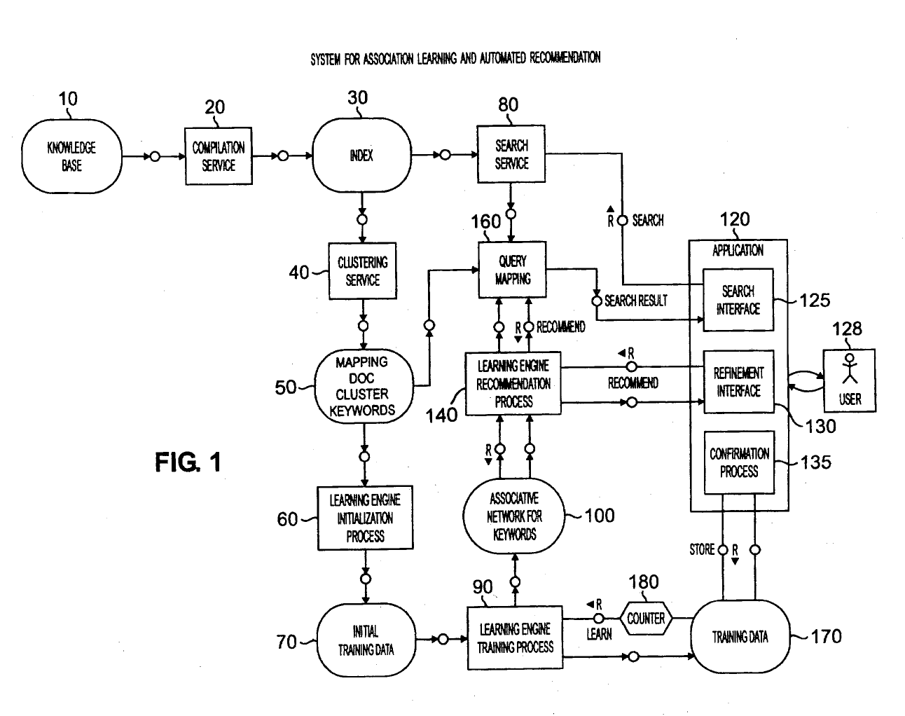

As shown in FIG. 1, a computer-based system provides for associative learning and automated recommendations. The system is designed to provide learning by updating correlations based upon user feedback.

As shown in FIG. 1, the system includes a knowledge base 10 that serves as a repository for information. Although only a single knowledge base 10 is illustrated in FIG. 1, the system may be configured to support multiple knowledge bases. The knowledge base 10 may include a collection of documents such as electronic mail (e-mail messages), web pages, business documents, etc. that may be searched and organized for users.

A compilation service 20 manages the transformation of textual based information in a knowledge base 10 into an index 30. The compilation service represents each document in a knowledge base as a vector. The components of a vector may correspond to a concept or term that may appear in the document and are commonly known as features. Feature vectors may be compiled into the index 30 which may be used as input by a search service 80.

The clustering service 40 may partition the index 30 into groups of documents similar in content, for example, into groups of feature vectors reflecting some minimum level of similarity. The partitioning of index 30 may provide an additional layer of organization to provide an overview of the contents of a knowledge base 10. The clustering service 40 may support various types of clustering including document partitioning algorithms such as k-means clustering, probabilistic clustering, etc. and hierarchical clustering algorithms such as agglomerative clustering and star clustering. In some implementations, the clustering service 40 may use a hierarchical clustering algorithm to determine an initial clustering which may be further refined using a k-means clustering algorithm. Many variants of the k-means algorithm may be used by the clustering service 40. In one implementation, a star algorithm may be used in the clustering service 40. The star algorithm may provide a hierarchical cluster depending upon the contents of the index 30. Each level in the hierarchy may be determined by a threshold minimum level of similarity between pairs of documents within a cluster at a particular level in the hierarchy. The star algorithm may reveal the topic-subtopic structure of the knowledge base 10. A topic summary for each cluster is provided by the center of the underlying star for the cluster. Other implementations may use alternate partitioning and hierarchical clustering algorithms.

A mapping 50 is provided by the clustering service 40. The mapping 50 contains information as to what documents belong to a particular cluster and what document features have been associated with a particular cluster. The mapping 50 may be used as input to a learning engine initialization process 60.

The learning engine initialization process 60 provides for learning of each entity type defined within the knowledge base 10 and may use the mapping 50 for initialization. In one implementation, the learning engine initialization process 60 transforms the feature relationships induced by the cluster structure into initial training data 70.

The generation of initial training data 70 may be implemented in various manners. In one implementation, identifying the relationship between features in the cluster structure may create feature-pairs. For example, if feature A and feature B reside in the same cluster, an entry for the feature-pair (A, B) will be created in the initial training data. In another implementation, feature-pairs may be created using the frequency proportional to their occurrence in the documents. For example, if feature A and feature B co-occur in the same document over five different documents, five entries for feature-pair (A, B) will be created in the initial training data. In other implementations, the generation of training data may use other heuristics to reflect the structure of the entity relationships given as input to initialization.

The training process 90 of the learning engine generates an associative network 100 using the initial training data 70 as input. Details of the learning engine training process are described below. In one implementation, the initial training data 70 is accessed only once and the associative network 100 is used for recommendations.

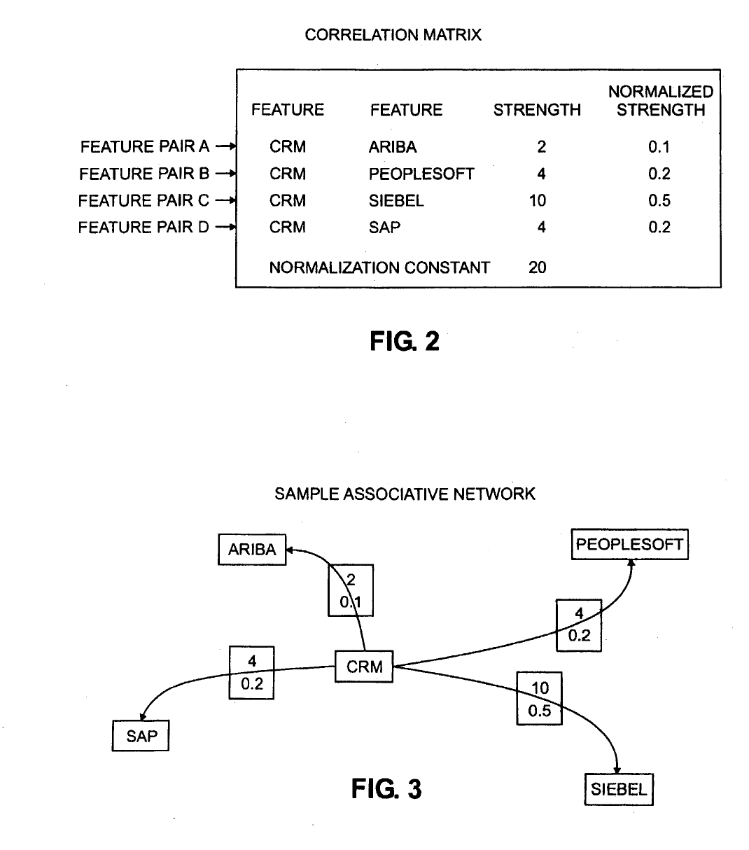

The associative network 100 may be represented as a correlation matrix. As shown in FIG. 2, a correlation matrix containing four feature-pairs is illustrated. For each feature-pair, a strength of association may be recorded. Referring to FIG. 2, feature-pair A has a strength of two, which after initial training indicates that feature-pair A has been observed two times in the initial training data 70.

Once strengths between feature-pairs have been assigned, the learning engine training process 90 may perform a data normalization process using feature-pair strengths as input. The learning engine training process 90 may calculate a normalization constant by summing all the strengths associated with feature-pairs in the correlation matrix. The learning engine training process 90 may then calculate a normalized strength for each feature-pair by dividing a feature-pair's strength by the normalization constant. For example, referring to FIG. 2, the normalized strength for feature-pair B is 0.2. A benefit of normalizing feature-pair strengths is that it may enhance the speed of learning and may facilitate comparison between feature-pairs during the learning engine recommendation process 140 described below. In addition, normalizing feature-pair strengths may allow for a proper derivation of higher order associations that may be used as spreading activation described below.

Referring to FIG. 1, once the initial training data 70 has been processed, the learning engine training process 90 may update the associative network 100 using the observed training data 170. The associative network 100 may be a directed graph containing nodes and weighted edges and may serve as a data source for providing recommendations. Nodes in the associative network 100 may represent features identified in the initial training data 70 and training data 170 and edges of the associative network may represent normalized strengths between stored feature-pairs.

FIG. 3 illustrates a sample associative network represented by the correlation matrix illustrated in FIG. 2. As illustrated in FIG. 3, five nodes representing distinct features (i.e. “CRM”, “Ariba”, “SAP”, “PeopleSoft”, and “Siebel”) from the correlation matrix are depicted. Arcs of the associative network may correspond to the normalized strengths calculated in the correlation matrix. For example, the arc between “CRM” and “Siebel” in FIG. 3 corresponds to the normalized strength of the “CRM-Siebel” feature-pair in the correlation matrix 70. Once the associative network 100 is established, advanced associative techniques may be employed to further discover relationships among features.

In one aspect, spreading activation may be employed to make recommendations from the associative network. Spreading activation may be characterized as a process that identifies knowledge assumed to be relevant to some focus of attention. A decay constant also may be defined to dampen the effect of activation that may spread through the associative network.

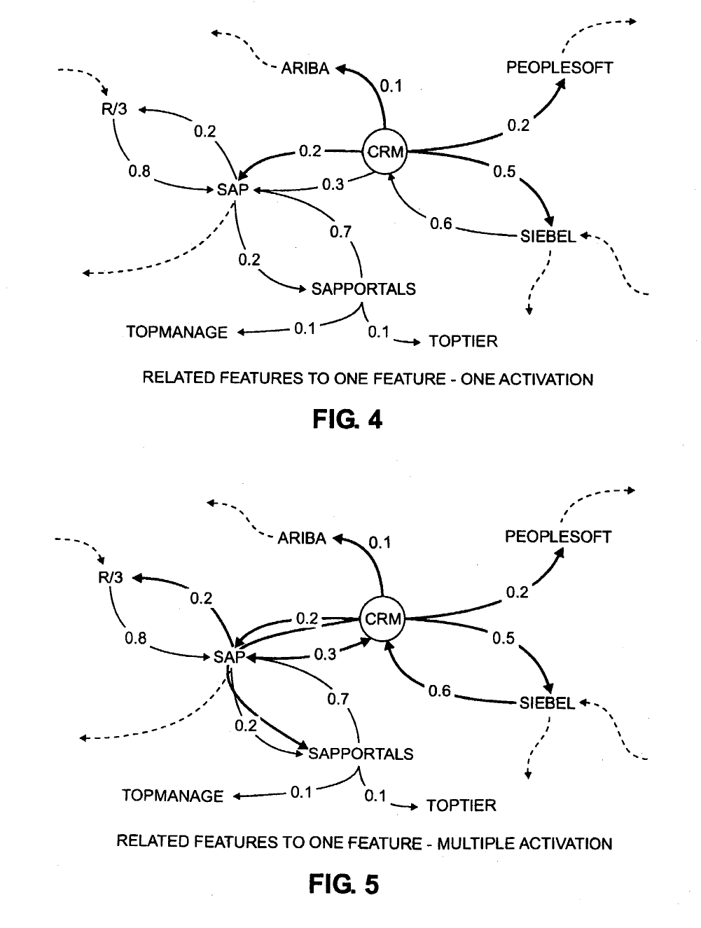

Spreading activation across an associative network is illustrated in FIG. 4. Activation may be pumped into one or more nodes of the associative network representing some starting input focus one or more times. Referring to FIG. 4, activation is being pumped once through the “CRM” node. The activation flows through the arcs of the graph structure with the amount of flow modulated by the arc strengths and dampened by the value selected for the decay variable. In one implementation, the following formula may be used for a 1-step activation:

Start-vector v=(v_{—}1, . . . , v_n), where v_i is the relevancy assigned to term i.

Recommendation-vector w=(w_{—}1, . . . , w_m), where w_j is the relevancy of term j within the recommendation.

Correlation matrix M=(m_ij), where m_ij is the directed normalized association of j pointing to i.

Decay-constant alpha with 0<=alpha<=1.

Spreading Activation (1-step):

w=[(1−alpha)+alphaM]v.

In some implementations, the number of spread activations and the value of the decay constant may be configurable parameters stored in a database. In another implementation, the learning engine training process 90 may store the spread activation network in a database table for subsequent access.

Spreading activation may be useful to deduce associations from an amount of data that is small in comparison to the overall number of possible feature-pairs.

FIG. 5 illustrates the effect of pumping multiple activations through the “CRM” node. In one implementation, the following formula may be used for pumping multiple activations:

Start-vector v=(v_{—}1, . . . , v_n), where v_i is the relevancy assigned to term i.

Recommendation-vector w=(w 1, . . . , w_k), where w_j is the relevancy of term j within the recommendation.

Correlation matrix M=(m_ij), where m_ij is the directed normalized association of j pointing to i.

Decay-constant alpha with 0<=alpha<=1.

Spreading Activation (k-step):

v\hat{ }(k)=(1−alpha)v\hat{ }(0)+alphaMv\hat{ }(k−1)

where v\hat{ }(0)=v.

As illustrated in FIG. 5, activation spreading may reveal an association between the “CRM” node and “SAPPortals” node even though no such association may exist in the correlation matrix. Although FIG. 5 illustrates features related to one particular feature, spreading activation may also be applied to multiple nodes and may reveal features related to a particular set of features. Furthermore, although only one associative network is illustrated in FIG. 5, multiple associative networks may be supported by the system.

Referring to FIG. 1, a user application 120 that interfaces with the learning engine recommendation process 140 may be provided. In particular, the user application 120 may have a search interface 125, a refinement interface 130, and a confirmation process 135.

The search interface 125 allows a user 128 to compose and submit a query to the search service 80 to receive information. The search service 80 may execute the query by accessing the index 30 and retrieving as a search result a list of documents that match the query features in descending sort order by similarity rank. For each document in the search result, information about the cluster assigned to the document may be passed. The search service 80 may pass the search result to the search interface 125 and also to a query mapping service 160.

The query mapping service 160 may use the search result and mapping 50 to identify document features corresponding to the cluster identified in the search result. The query mapping service may pass these document features to the learning engine recommendation process 140 as an initial point of focus for recommendations.

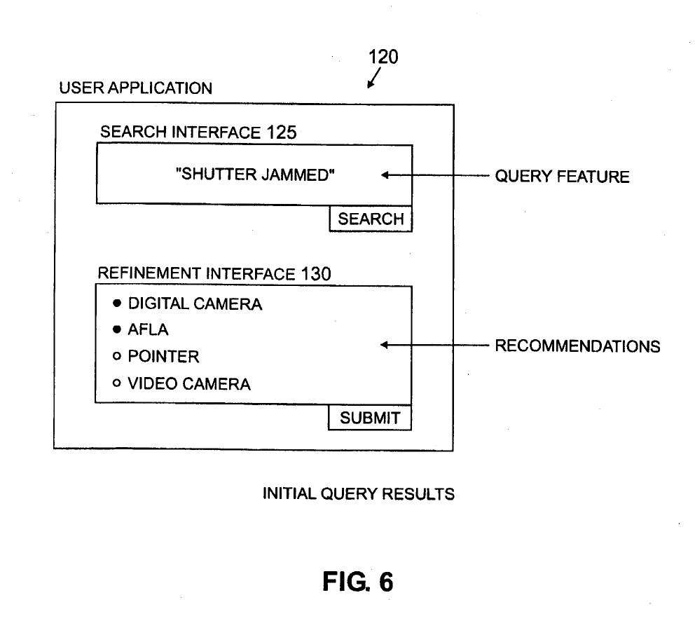

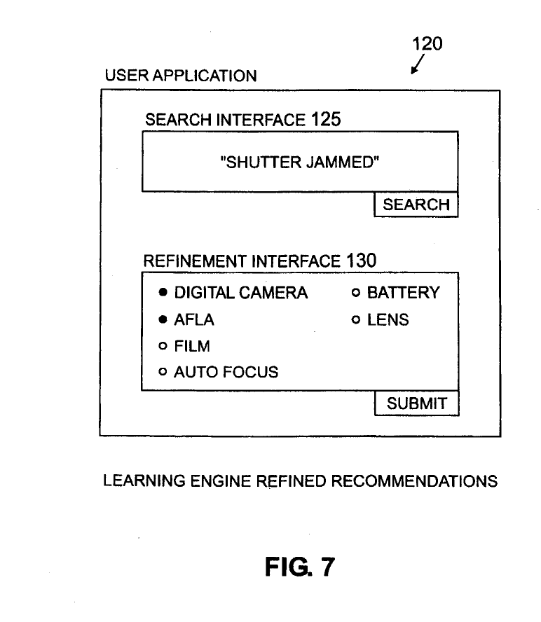

The refinement interface 130 of the user application 120 interacts directly with the learning engine recommendation process 140 and may provide additional input focus for recommendations. For example, referring to FIG. 6, an initial query may be composed of the query feature “shutter jammed”. As illustrated in FIG. 6, initial recommendations from the learning engine may include “Digital Camera”, “AGFA”, “Printer”, and “Video Camera”. A user may select one or more recommendations and submit these recommendations along with query features to the learning engine recommendation process 140. Referring to FIG. 7, a user selecting the recommendations of “Digital Camera” and “AGFA” in combination with the query feature “shutter jammed” may result in the learning engine refining its recommendations to the following set: “Digital Camera”, “AGFA”, “Film”, “Autofocus”, “Battery” and “Lens”. For each refinement request, the learning engine recommendation process may access the association network 100 to retrieve recommendations.

Referring to FIG. 1, the confirmation process 135 provides a method for collecting training-data 170 for learning algorithms. Collecting training-data 170 data may be done either in explicit form by posing questions to the user, or in an implicit form by observing selected actions by the user. Either method of feedback, implicit, explicit, or both may be supported by the system.

The confirmation process 135 may store both the initial input focus and the final set of recommendations from the learning engine recommendation process 140. For example, a user may begin searching the Internet for information relating to automobiles and petroleum. Using the refinement interface 130, the user may conclude the search by focusing on a learning engine recommendation of “motor oil”. The confirmation process 135 may store the initial input focus (e.g. “automobiles” and “petroleum”) and final recommendation (“motor oil”) in a database table and use this data as training-data 170 for subsequent learning.

The learning engine training process 90 may, in an asynchronous fashion, create a copy of the correlation matrix representing the associative network 100, transform the stored training-data 170 into adaptation data comprising feature-pairs, update the copy of the correlation data using the feature-pairs as input, and replace the correlation matrix representing the associative network 100 with the updated copy. In other implementations, the learning engine training process 90 may update the associative network 100 by modifying the underlying correlation matrix directly.

In one implementation, the transformation of data may be triggered by the amount of training-data 170 that may be stored. For example, a counter 180 may be incremented each time training-data 170 is stored. Once a threshold level is reached, the transformation of training-data 170 into feature-pairs and the corresponding updates to the correlation matrix 70 may commence. Other implementations may transform training-data 170 into feature-pairs and update the correlation matrix 70 each time new training data 170 is stored by the confirmation process 135.

Learning rules may be applied to the training-data 170 to generate entity-pairs. Various types of learning rules may be implemented by the learning engine and may be used in combination. Although only three learning rules are discussed below, the learning engine training process 90 may implement additional or different rules.

Co-occurrence based correlation-learning means that for each given set of entities the co-occurrence weight of all contained pairs of different elements are strengthened. The learning rule may be formulated as forming all pairs of different entities contained in a submitted set of entities and adding them to the correlation matrix. For example, collected training-data 170 may be composed of the final set of training data {a, b, c}. Applying the co-occurrence learning rule to the final set may yield the following feature-pairs {(a,b),(a,c),(b,a),(b,c),(c,a),(c,b)}. If the distribution of co-occurrence sets forwarded to the learning engine is static and is randomly sampled, then the correlation strengths may converge to the probability of a pair of entities being present in such a set averaged over the given distribution of sets. Typically, however, where there may be changes in the environment, the distributions of co-occurrence sets may be dynamic. As a result, the co-occurrence learning rule may provide the possibility of adapting to those changes. Learning engine recommendations based on co-occurrence learning may result in recommending entities that are similar in the sense that they frequently are observed in combination with each other.

Navigation-based correlation learning means that for given initial and final sets of entities, a reduced path through the sets of entities may be interpreted which may reflect knowledge. The learning rule can be formulated as forming all pairs of different entities where a first entity is from a submitted initial set of entities, the second entity is from a submitted final set, neither the first entity nor second entity appears in both the initial set and final set of entities, and adding all pairs of different entities to the correlation matrix. For example, collected training-data 170 from the confirmation process 135 may be composed of an initial set training-data composed of {a, b, c} and a final set of training-data composed of {b, d, e}. Applying the navigation based learning rule to the training-data may yield the following feature-pairs {(a, d), (a, e), (c, d), (c, e)}. A benefit of navigation-based correlation learning may be that recommendations based on these reduced paths may be explorative and may be driven by navigational patterns pointing a user in new directions.

Sequence-based correlation learning means that a given sequence of entities is interpreted as a directed path through the space of all entities. The learning rule may be formulated as forming all pairs of different entities where the second entity is a successor in the entity sequence compared to the first entity and adding pairs of different entities to the adaptation-data. For example, collected training-data may be composed of a sequence-based set of training data composed of {A>B>C>D}. Applying the sequence-based correlation-learning rule to this set may yield the following feature-pairs {(A>B), (B>C), (C>D)}. Learning engine recommendations based on sequences may be strongly directed to “specialization” as long as the correlations of entities exhibit a directed hierarchical structure and the nodes correspond to “specialized” entities. For example, products from a product catalogue, where the catalogue structure can be interpreted as defining such a correlation structure.

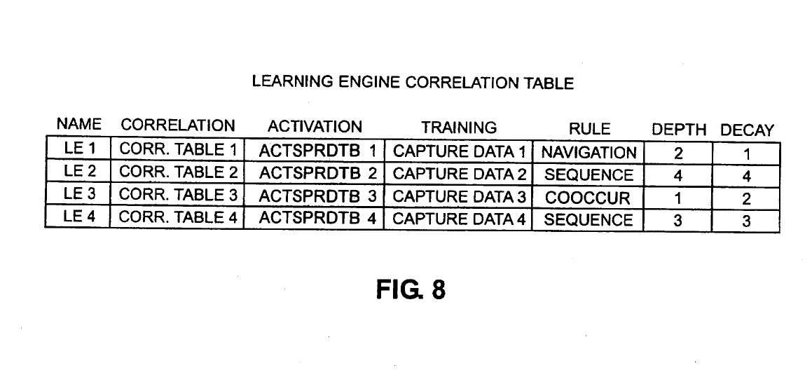

Multiple learning engines may be supported by the system. Different configurations of learning engines may be stored in a learning engine customizing table. As shown, for example, in FIG. 8, each learning engine configuration may be identified by a name. The customization parameters for each learning engine configuration may include: name of database-table containing correlations, name of database-table containing activation-spread correlations, name of database-table containing training-data, learning rules that may be applied, and activation spreading parameters such as depth of spreading and decay constant.

Various features of the system may be implemented in hardware, software, or a combination of hardware and software. For example, some features of the system may be implemented in computer programs executing on programmable computers. Each program may be implemented in a high level procedural or object-oriented programming language to communicate with a computer system or other machine. Furthermore, each such computer program may be stored on a storage medium such as read-only-memory (ROM) readable by a general or special purpose programmable computer or processor, for configuring and operating the computer to perform the functions described above.

Other implementations are within the scope of the claims.

What is claimed is:

1. A method comprising:
generating correlation data from initialization data representing relations between entities;
generating a directed graph from the correlation data;
providing one or more recommendations from the directed graph using a request as input;
storing training data in response to user activity; and
adapting the correlation data using the training data as input.

2. The method of claim 1 wherein generating the correlation data comprises:
forming an entity-pair from the initialization data;
computing a strength of association for the entity-pair; and
computing a normalized strength of association for the entity-pair, wherein the correlation data includes the normalized strength of association.

3. The method of claim 2 wherein computing a strength of association comprises calculating a frequency of occurrence for the entity-pair in the initialization data.

4. The method of claim 2 wherein computing the normalized strength of association comprises:
calculating a normalization constant by summing the strength of association for each entity-pair; and
calculating the normalized strength of association by dividing the strength of association by the normalization constant.

5. The method of claim 1 wherein generating the directed graph comprises:
generating nodes from the correlation data using entity-pairs as input; and
generating arcs connecting the nodes using normalized strengths between the entity-pairs as input.

6. The method of claim 1 wherein providing recommendations comprises:
receiving the request from a user;
accessing a first set of one or more nodes on the directed graph matching the request;
traversing one or more arcs connected to the first set of one or more nodes;
accessing a second set of one or more nodes connected to one or more arcs; and
recommending the second set of one or more nodes to the user.

7. The method of claim 6 wherein traversing one or more arcs connected to the first set of one or more nodes comprises:
obtaining an arc strength from an arc;
comparing the arc strength to a pre-defined value; and
determining whether to traverse the arc based on the comparison.

8. The method of claim 6 wherein providing one or more recommendations comprises applying spread activation to the first set of one or more nodes.

9. The method of claim 8 wherein applying spread activation comprises:
obtaining a level of activation from a database table;
obtaining a decay constant from a database table;
applying a spreading activation algorithm to the first set of one or more nodes.

10. The method of claim 1 further comprising:
displaying an interface prompting feedback from the user regarding the quality of the recommendations; and
determining whether to store the request and one or more recommendations in a database as the training data based upon the feedback.

11. The method of claim 1 further comprising:
observing selected actions by a user based on one or more recommendations; and
determining whether to store the request and the recommendations in a database as the training data based upon the selected actions.

12. The method of claim 1 wherein adapting correlation data comprises:
accessing the training data using access controls;
generating adaptation data from a learning rule using the training data as input; and
adapting the correlation data using the adaptation data as input.

13. The method of claim 12 wherein generating adaptation data from the learning rule comprises:
accessing a data set in the training data;
forming an entity-pair based on the co-occurrence of elements in the data set;
determining whether the entity-pair exists in the adaptation data; and
adding the entity-pair to the adaptation data if the entity-pair does not exist in the adaptation data.

14. The method of claim 12 wherein generating the adaptation data from the learning rule comprises:
accessing a first data set in the training data;
accessing a second data set in the training data corresponding to the initial set;
forming an entity-pair wherein a first entity is in the first data set, a second entity is in the second data set, and the first entity and the second entity in combination are not in either the first data set or second data set;
determining whether the entity-pair exists in the adaptation data; and
adding the entity-pair to the adaptation data if the entity-pair does not exist in the adaptation data.

15. The method of claim 12 wherein generating the adaptation data from the learning rule comprises:
accessing a sequenced data set in the training data;
forming an entity-pair which consists of a first and second entity from the sequenced data set wherein the second entity immediately follows the first entity;
determining whether the entity-pair exists in the adaptation data; and
adding the entity-pair to the adaptation data if the entity-pair does not exist in the adaptation data.

16. The method of claim 12 wherein adapting correlation data using the adaptation data as input comprises:
triggering a copy of the correlation data to a second correlation data;
adding entity-pairs from the adaptation data to the second correlation data;
calculating a strength of association for the entity pairs in the second correlation data;
calculating a normalized strength of association for the entity-pairs in the second correlation data; and
overlaying the correlation data with the second correlation data.

17. The method of claim 16 wherein adapting correlation data using the adaptation data as input further comprises determining whether a threshold amount of training data is collected.

18. The method of claim 16 wherein adapting correlation data using the adaptation data as input is performed asynchronously.

19. An article comprising a machine-readable medium storing machine-readable instructions that, when applied to the machine, cause the machine to:
generate correlation data from initialization data representing associations between entities;
generate a directed graph from the correlation data;
provide one or more recommendations from the directed graph using a request as input;
store training data in response to user activity; and
adapt the correlation data using the training data as input.

20. The article of claim 19 including instructions that, when applied to the machine, cause the machine to:
form an entity-pair from the initialization data;
compute a strength of association for the entity-pair; and
compute a normalized strength of association for the entity-pair, wherein the correlation data includes the normalized strength of association.

21. The article of claim 20 including instructions that, when applied to the machine, cause the machine to compute a strength of association by calculating a frequency of occurrence for the entity-pair in the initialization data.

22. The article of claim 20 including instructions that, when applied to the machine, cause the machine to:
calculate a normalization constant by summing the strength of association for each entity-pair; and
calculate the normalized strength of association by dividing the strength of association by the normalization constant.

23. The article of claim 19 including instructions that, when applied to the machine, cause the machine to:
generate nodes from the correlation data using entity-pairs as input; and
generate arcs connecting the nodes using normalized strengths between the entity-pairs as input.

24. The article of claim 19 including instructions that, when applied to the machine, cause the machine to:
access a first set of one or more nodes on the directed graph matching the request in response to receiving the request from a user;
traverse one or more arcs connected to the first set of one or more nodes;
access a second set of one or more nodes connected to one or more arcs; and
recommend the second set of one or more nodes to the user.

25. The article of claim 24 including instructions that, when applied to the machine, cause the machine to:
obtain an arc strength from an arc;
compare the arc strength to a pre-defined value; and
determine whether to traverse the arc based on the comparison.

26. The article of claim 24 including instructions that, when applied to the machine, cause the machine to apply spread activation to the first set of one or more nodes.

27. The article of claim 26 including instructions that, when applied to the machine, cause the machine to:
obtain a level of activation from a database table;
obtain a decay constant from a database table; and
apply a spreading activation algorithm to the first set of one or more nodes.

28. The article of claim 19 including instructions that, when applied to the machine, cause the machine to:
display an interface prompting feedback from the user regarding the quality of the recommendations; and
determine whether to store the request and one or more recommendations in a database as the training data based upon the feedback.

29. The article of claim 19 including instructions that, when applied to the machine, cause the machine to:
observe selected actions by a user based on one or more recommendations; and
determine whether to store the request and the recommendations in a database as the training data based upon the selected actions.

30. The article of claim 19 including instructions that, when applied to the machine, cause the machine to:
access the training data using access controls;
generate adaptation data from a learning rule using the training data as input; and
adapt the correlation data using the adaptation data as input.

31. The article of claim 30 including instructions that, when applied to the machine, cause the machine to:
access a data set in the training data;
form an entity-pair based on the co-occurrence of elements in the data set;
determine whether the entity-pair exists in the adaptation data; and
add the entity-pair to the adaptation data if the entity-pair does not exist in the adaptation data.

32. The article of claim 30 including instructions that, when applied to the machine, cause the machine to:
access a first data set in the training data;
access a second data set in the training data corresponding to the initial set;
form an entity-pair wherein a first entity is in the first data set, a second entity is in the second data set, and the first entity and the second entity in combination are not in either the first data set or second data set;
determine whether the entity-pair exists in the adaptation data; and
add the entity-pair to the adaptation data if the entity-pair does not exist in the adaptation data.

33. The article of claim 30 including instructions, that when applied to the machine, cause the machine to:
access a sequenced data set in the training data;
form an entity-pair which consists of a first and second entity from the sequenced data set wherein the second entity immediately follows the first entity;
determine whether the entity-pair exists in the adaptation data; and
add the entity-pair to the adaptation data if the entity-pair does not exist in the adaptation data.

34. The article of claim 30 including instructions that, when applied to the machine, cause the machine to:
trigger a copy of the correlation data to a second correlation data;
add entity-pairs from the adaptation data to the second correlation data;
calculate a strength of association for the entity-pairs in the second correlation data;
calculate a normalized strength of association for the entity-pairs in the second correlation data; and
overlay the correlation data with the second correlation data.

35. The article of claim 34 including instructions that, when applied to the machine, cause the machine to determine whether a threshold amount of training data is collected.

36. The article of claim 34 including instructions that, when applied to the machine, cause the machine to adapt correlation data using the adaptation data as input asynchronously.

37. A system comprising:
a computer network;
a directory coupled to the network, the directory storing correlation data, training data, and configuration data;
user interfaces coupled to the network to allow each user independently to request and receive recommendations; and
a service delivery device coupled to the network, the service delivery device including a processor and memory storing instructions that, in response to receiving a request for recommendations, cause the processor to:
generate the correlation data from initialization data representing associations between entities;
generate a directed graph from the correlation data;
provide one or more recommendations from the directed graph using a request as input;
store the training data in response to user activity; and
adapt the correlation data using the training data as input.

38. The system of claim 37 wherein the memory stores instructions that, in response to receiving the request, cause the processor to:
form an entity-pair from the initialization data;
compute a strength of association for the entity-pair; and
compute a normalized strength of association for the entity-pair, wherein the correlation data includes the normalized strength of association.

39. The system of claim 38 wherein the memory stores instructions that, in response to receiving the request, cause the processor to compute a strength of association by calculating a frequency of occurrence for the entity-pair in the initialization data.

40. The system of claim 38 wherein the memory stores instructions that, in response to receiving the request, cause the processor to:
calculate a normalization constant by summing the strength of association for each entity-pair; and
calculate the normalized strength of association by dividing the strength of association by the normalization constant.

41. The system of claim 37 wherein the memory stores instructions that, in response to receiving the request, cause the processor to:
generate nodes from the correlation data using entity-pairs as input; and
generate arcs connecting the nodes using normalized strengths between the entity-pairs as input.

42. The system of claim 37 wherein the memory stores instructions that, in response to receiving the request, cause the processor to:
access a first set of one or more nodes on the directed graph matching the request in response to receiving the request from a user;
traverse one or more arcs connected to the first set of one or more nodes;
access a second set of one or more nodes connected to one or more arcs; and
recommend the second set of one or more nodes to the user.

43. The system of claim 42 wherein the memory stores instructions that, in response to receiving the request, cause the processor to:
obtain an arc strength from an arc;
compare the arc strength to a pre-defined value; and
determine whether to traverse the arc based on the comparison.

44. The system of claim 42 wherein the memory stores instructions that, in response to receiving the request, cause the processor to apply spread activation to the first set of one or more nodes.

45. The system of claim 44 wherein the memory stores instructions that, in response to receiving the request, cause the processor to:
obtain a level of activation from a database table;
obtain a decay constant from a database table; and
apply a spreading activation algorithm to the first set of one or more nodes.

46. The system of claim 37 wherein the memory stores instructions that, in response to receiving the request, cause the processor to:
display an interface prompting feedback from the user regarding the quality of the recommendations; and
determine whether to store the request and one or more recommendations in a database as the training data based upon the feedback.

47. The system of claim 37 wherein the memory stores instructions that, in response to receiving the request, cause the processor to:
observe selected actions by a user based on one or more recommendations; and
determine whether to store the request and the recommendations in a database as the training data based upon the selected actions.

48. The system of claim 37 wherein the memory stores instructions that, in response to receiving the request, cause the processor to:
access the training data using access controls;
generate adaptation data from a learning rule using the training data as input; and
adapt the correlation data using the adaptation data as input.

49. The system of claim 48 wherein the memory stores instructions that, in response to receiving the request, cause the processor to:
access a data set in the training data;
form an entity-pair based on the co-occurrence of elements in the data set;
determine whether the entity-pair exists in the adaptation data; and
add the entity-pair to the adaptation data if the entity-pair does not exist in the adaptation data.

50. The system of claim 48 wherein the memory stores instructions that, in response to receiving the request, cause the processor to:
access a first data set in the training data;
access a second data set in the training data corresponding to the initial set;
form an entity-pair wherein a first entity is in the first data set, a second entity is in the second data set and the first entity and the second entity in combination are not in either the first data set or second data set;
determine whether the entity-pair exists in the adaptation data; and
add the entity-pair to the adaptation data if the entity-pair does not exist in the adaptation data.

51. The system of claim 48 wherein the memory stores instructions that, in response to receiving the request, cause the processor to:
access a sequenced data set in the training data;
form an entity-pair which consists of a first and second entity from the sequenced data set wherein the second entity immediately follows the first entity;
determine whether the entity-pair exists in the adaptation data; and
add the entity-pair to the adaptation data if the entity-pair does not exist in the adaptation data.

52. The system of claim 48 wherein the memory stores instructions that, in response to receiving the request, cause the processor to:
trigger a copy of the correlation data to a second correlation data;
add entity-pairs from the adaptation data to the second correlation data;
calculate a strength of association for the entity pairs in the second correlation data;
calculate a normalized strength of association for the entity-pairs in the second correlation data; and
overlay the correlation data with the second correlation data.

53. The system of claim 52 wherein the memory stores instructions that, in response to receiving the request, cause the processor to determine whether a threshold amount of training data is collected.

54. The system of claim 52 wherein the memory stores instructions that, in response to receiving the request, cause the processor to adapt correlation data using the adaptation data as input asynchronously.
